(19) United States
(12) Patent Application Publication
(10) Pub. No.: US 2025/0180410 A1
(43) Pub. Date: Jun. 5, 2025

(54) ELECTRONIC APPARATUS THAT ESTIMATES AMBIENT TEMPERATURE AND CONTROL METHOD THEREOF

(71) Applicant: CANON KABUSHIKI KAISHA, Tokyo (JP)

(72) Inventor: DAISUKE YOSHIDA, Kanagawa (JP)

(21) Appl. No.: 18/961,223

(22) Filed: Nov. 26, 2024

(30) Foreign Application Priority Data
Dec. 4, 2023 (JP) 2023-204910

(51) Int. Cl. G01K 7/42; G01K 3/10; G01K 3/14; G06F 1/20

(52) U.S. Cl. CPC G01K 7/427; G01K 3/10; G01K 3/14; G06F 1/206

(57) ABSTRACT

An electronic apparatus includes a cooling unit that cools an inside of the electronic apparatus, a temperature measuring unit that measures a temperature inside the electronic apparatus, and a controller that controls an operation of the cooling unit. The controller performs processing of estimating an ambient temperature in a usage environment of the electronic apparatus based on temperature information obtained by the temperature measuring unit, controls a timing of performing estimation processing for the ambient temperature based on an operation state of the cooling unit, and controls an operation of the electronic apparatus based on the ambient temperature.

### BACKGROUND

### Technical Field

The present disclosure relates to a technical field for estimating an ambient temperature in a usage environment of an electronic apparatus.

### Description of the Related Art

In an electronic apparatus such as a digital camera, as the load of image capture processing or image processing increases due to, for example, an increase in the resolution of an image to be captured, electronic devices (to be referred to as heat source devices) constituting an image capture unit, a control unit, and the like generate heat at the time of image capturing, thus raising the temperatures of the interior of the apparatus and the casing. It is, therefore, necessary to perform control to restrict the operation of the electronic apparatus so as not to exceed the operation guarantee temperature of a heat source device and to restrict the operation of the electronic apparatus so as to prevent an excessive increase in the temperature of the casing which the user directly touches.

In restricting the operation of the electronic apparatus based on the outer casing temperature, it is necessary to appropriately set a threshold for the outer casing temperature (to be referred to as the outer casing temperature threshold hereinafter) that restricts the operation of the electronic apparatus based on the ambient temperature in the usage environment of the electronic apparatus. In order to appropriately set an outer casing temperature threshold, it is necessary to obtain an accurate ambient temperature. However, in a case where an estimated ambient temperature is higher than an actual ambient temperature, the outer casing temperature can exceed the outer casing temperature threshold. In a case where the estimated ambient temperature is lower than the actual ambient temperature, the outer casing temperature threshold can decrease or the operable time of the electronic apparatus can shorten.

Japanese Patent Laid-Open No. 2013-41934 discloses a method of estimating an ambient temperature according to a predetermined relation expression from the difference between the temperatures of a thermometer installed inside an electronic apparatus which are obtained at different timings. Japanese Patent Laid-Open No. 2011-27644 discloses a method of estimating an ambient temperature from the time at which the temperature of a thermometer installed inside an electronic apparatus drops after the stop of the energization of the electronic apparatus.

According to the methods disclosed in Japanese Patent Laid-Open Nos. 2013-41934 and 2011-27644, the heat dissipation time may change between a portion in the electronic apparatus which is cooled by a cooling device and a portion that is not cooled by the cooling device, and the temperatures of thermometers at the respective portions differ from each other. This may cause a deterioration in the estimation accuracy of an ambient temperature. In addition, the method disclosed in Japanese Patent Laid-Open No. 2011-27644 cannot estimate an ambient temperature during the operation of the electronic apparatus.

### SUMMARY

The present disclosure has been made in consideration of the above and realizes techniques of improving the estimation accuracy of an ambient temperature when the electronic apparatus is cooled.

The present disclosure provides an electronic apparatus comprising a cooling unit that cools an inside of the electronic apparatus, a temperature measuring unit that measures a temperature inside the electronic apparatus, and a controller that controls an operation of the cooling unit, wherein the controller performs processing of estimating an ambient temperature in a usage environment of the electronic apparatus based on temperature information obtained by the temperature measuring unit, controls a timing of performing estimation processing for the ambient temperature based on an operation state of the cooling unit, and controls an operation of the electronic apparatus based on the ambient temperature.

The present disclosure provides a method for controlling an electronic apparatus, the electronic apparatus includes a cooling unit that cools an inside of the electronic apparatus and a temperature measuring unit that measures a temperature inside the electronic apparatus, wherein the method comprises estimating an ambient temperature in a usage environment of the electronic apparatus based on temperature information obtained by the temperature measuring unit, controlling a timing at which estimation processing for the ambient temperature is performed based on an operation state of the cooling unit, and controlling an operation of the electronic apparatus based on the ambient temperature.

Further features of the present disclosure will become apparent from the following description of exemplary embodiments with reference to the attached drawings.

### BRIEF DESCRIPTION OF THE DRAWINGS

FIG. 1 is a block diagram illustrating the configuration of an electronic apparatus according to a present embodiment;

FIG. 2 is a view illustrating an example of the placement of a temperature measuring unit according to the present embodiment;

FIG. 3 is a flowchart illustrating ambient temperature estimation processing and operation restriction processing of the electronic apparatus;

FIG. 4 is a view illustrating the relationship between the operation state of a cooling unit and the ambient temperature update time according to the present embodiment.

FIGS. 5A and 5B illustrate display examples of ambient temperatures according to the present embodiment.

### DESCRIPTION OF THE EMBODIMENTS

Hereinafter, embodiments will be described in detail with reference to the attached drawings. The following embodiments are not intended to limit the scope of the claimed features of the present disclosure. Multiple features are described in the embodiments, but these embodiments are not seen to be limiting, and multiple such features can be combined as appropriate. In the attached drawings, the same reference numerals are given to the same or similar configurations, and redundant description thereof is omitted.

### <Apparatus Configuration>

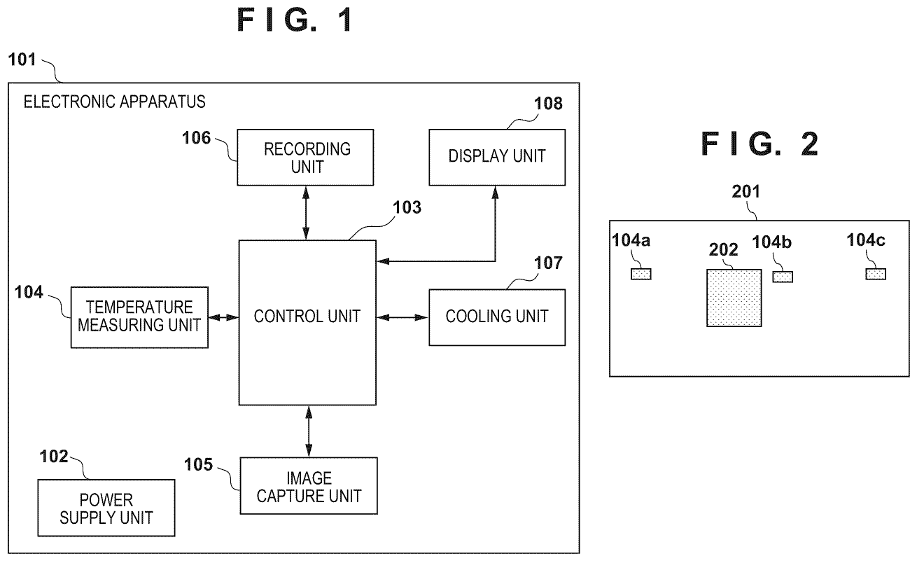

The configuration and function of an electronic apparatus according to the present embodiment will be described with reference to FIGS. 1 and 2.

The present embodiment is an example of a case where the electronic apparatus is an image capture apparatus such as a digital camera. The electronic apparatus is not limited to an image capture apparatus and can be a portable information terminal such as a smartphone or tablet device or another apparatus including a cooling unit that cools a heat source device.

As illustrated in FIG. 1, an electronic apparatus 101 includes a power supply unit 102, a control unit 103, a temperature measuring unit 104, an image capture unit 105, a recording unit 106, a cooling unit 107, and a display unit 108.

The power supply unit 102 supplies power to each component of the electronic apparatus 101. The power supply unit 102 includes, for example, a power supply IC including a DC/DC converter. The power supply unit 102 converts, for example, the voltage supplied from a power supply such as a battery or AC adapter (not shown) into a voltage on which each component of the electronic apparatus 101 can operate.

The control unit 103 controls the electronic apparatus 101. The control unit 103 includes, for example, a system LSI including a microprocessor and a memory chip such as a DRAM. The control unit 103 controls the temperature measuring unit 104, the image capture unit 105, the recording unit 106, and the cooling unit 107 (which are described below).

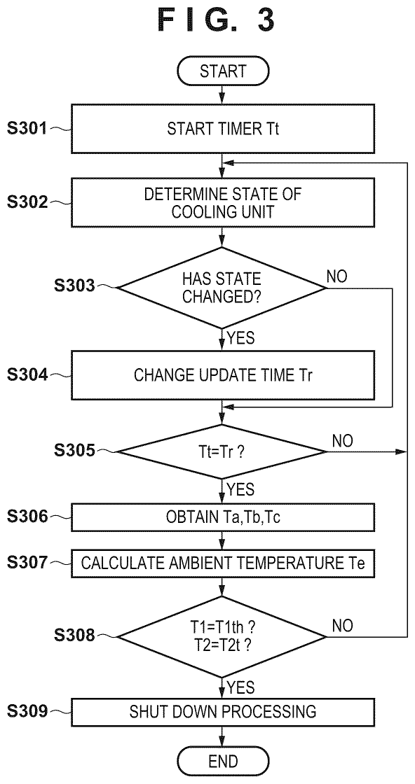

The temperature measuring unit 104 measures the internal temperature of the electronic apparatus 101 and transmits temperature information as a measurement result to the control unit 103. The temperature measuring unit 104 includes, for example, a thermistor or a digital thermometer. The temperature measuring unit 104 is placed at a position where it can measure the temperature of the outer casing of the electronic apparatus 101 (to be referred to as an outer casing temperature hereinafter) or the temperature of a device as a heat source (to be referred to as a heat source device hereinafter) inside the electronic apparatus 101 in the control processing described below with reference to FIG. 3.

The outer casing temperature of the electronic apparatus 101 is the temperature of an outer casing portion such as the housing of the electronic apparatus 101. For example, in a case where the electronic apparatus 101 is an image capture apparatus, the outer casing temperature is the temperature of a grip portion with which the user holds the image capture apparatus.

In the present embodiment, heat source devices are, for example, the system LSI and the memory IC of the control unit 103, the power supply IC of the power supply unit 102, and the sensor unit of the image capture unit 105.

The image capture unit 105 includes an image sensor implemented by a photoelectric conversion element such as a CMOS or CCD sensor. The image capture unit 105 transmits the image data captured by the image sensor to the control unit 103.

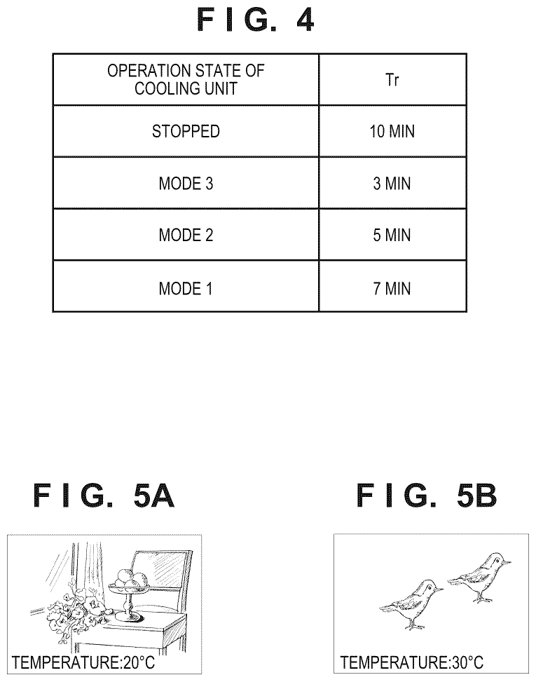

The recording unit 106 is a nonvolatile memory such as a ROM, a memory card, a hard disk, or the like. The recording unit 106 stores information indicating an arithmetic expression for an outer casing temperature, information indicating the correlation between an ambient temperature in the usage environment of the electronic apparatus 101 and the outer casing temperature threshold of the electronic apparatus 101, information indicating the correlation between the operation state of the cooling unit 107, the cooling capacity, and the portion to be cooled, and the like. These pieces of information are generated in advance by performing experiments and learning processing. The operation state of the cooling unit 107 includes a plurality of modes corresponding to the driven states of the cooling unit 107 illustrated in FIG. 4, and the cooling capacity differs for each mode. The driven state of the cooling unit 107 includes a stopped state in which the cooling unit 107 is not driven. In the case illustrated in FIG. 4, the cooling capacity of the cooling unit 107 is the lowest when the cooling unit 107 is stopped and sequentially increases in the order of mode 1, mode 2, and mode 3.

The cooling unit 107 performs cooling to reduce rises in the temperatures of the outer casing portion of the electronic apparatus 101 and a heat source device inside the electronic apparatus 101. The cooling unit 107 includes, for example, a blast fan or Peltier element. The control unit 103 can control the cooling capacity of the cooling unit 107 by controlling the amount of current supplied to the blast fan or the Peltier element. In a case where the temperature of the heat source device is high, the cooling unit 107 needs to have a high cooling capacity. Accordingly, the driving power of the cooling unit 107 increases with a rise in temperature of the heat source device.

In a case where the outer casing temperature of the electronic apparatus 101 exceeds the outer casing temperature threshold, the control unit 103 performs control to restrict the operation of the electronic apparatus 101. The outer casing temperature threshold is set based on the ambient temperature in the usage environment of the electronic apparatus. In addition, in a case where the temperature of a heat source device exceeds the heat source device temperature threshold, the control unit 103 performs control to restrict the operation of the heat source device.

As illustrated in FIG. 2, the temperature measuring unit 104 according to the present embodiment is mounted on a substrate 201 on which a heat source device 202 is mounted. The temperature measuring unit 104 includes a first thermometer 104a, a second thermometer 104b, and a third thermometer 104c and is placed as illustrated in FIG. 2. In the case illustrated in FIG. 2, the second thermometer 104b is placed nearest the heat source device 202, the third thermometer 104c is placed farthest from the heat source device 202, and the first thermometer 104a is placed farther from the heat source device 202 than the second thermometer 104b and nearer the heat source device 202 than the third thermometer 104c.

The first thermometer 104a and the third thermometer 104c are mainly used to monitor the outer casing temperature of the electronic apparatus 101. The second thermometer 104b is mainly used to monitor the temperature of the heat source device 202. The first thermometer 104a, the second thermometer 104b, and the third thermometer 104c transmit temperature information as measurement results to the control unit 103.

In the present embodiment, the control unit 103 performs arithmetic processing for an ambient temperature based on first temperature information Ta measured by the first thermometer 104a, second temperature information Tb measured by the second thermometer 104b, and third temperature information Tc measured by the third thermometer 104c.

In the present embodiment, an ambient temperature Te is calculated by substituting the first temperature information Ta measured by the first thermometer 104a, the second temperature information Tb measured by the second thermometer 104b, and the third temperature information Tc measured by the third thermometer 104c into equation (1) below:

$$Te = a \times Ta + b \times Tb + c \times Tc \qquad ( 1 )$$

The coefficients a, b, and c of equation (1) are obtained by, for example, performing experiments and learning processing in advance based on the temperature rise characteristics of the electronic apparatus 101.

The cooling unit 107 cools the outer casing portion monitored by the first thermometer 104a and the heat source device 202 monitored by the second thermometer 104b.

### <Control Processing>

Ambient temperature estimation processing and operation restriction processing by the electronic apparatus 101 according to the present embodiment will now be described with reference to FIG. 3.

The processing in FIG. 3 is implemented by the control unit 103 controlling each component of the electronic apparatus 101 by executing the programs stored in the recording unit 106. The processing in FIG. 3 is executed with a predetermined period (for example, a period of 1 sec) after the start of the electronic apparatus 101.

In step S301, the control unit 103 starts time measurement by resetting a measurement time Tt of a built-in timer to 0.

In step S302, the control unit 103 determines the operation state of the cooling unit 107.

In step S303, the control unit 103 determines whether the operation state of the cooling unit 107 determined in step S302 has changed. When the control unit 103 determines that the operation state of the cooling unit 107 has changed, the processing proceeds to step S304. When the control unit 103 determines that the operation state of the cooling unit 107 has not changed, the control unit 103 proceeds to step S305.

In step S304, the control unit 103 sets an ambient temperature update time Tr. The control unit 103 changes the ambient temperature update time Tr based on the operation state of the cooling unit 107 as illustrated in FIG. 4, resets the measurement time Tt of the timer, and resumes the time measurement from 0. The ambient temperature update time is the time interval at which ambient temperature estimation processing is performed. In the case illustrated in FIG. 4, the higher the cooling capacity of the cooling unit 107, the shorter the ambient temperature update time. For example, in a case where the operation state of the cooling unit 107 has changed from “stop” to “mode 1”, the ambient temperature update time Tr is set to 3 min. In addition, after the electronic apparatus 101 is activated in an initial state, for example, a state in which the cooling unit 107 is stopped, the operation state of the cooling unit 107 is “stop”, and hence the ambient temperature update time Tr is set to 10 min.

In step S305, the control unit 103 determines whether the measurement time Tt of the timer has reached the ambient temperature update time Tr. In a case where the control unit 103 determines that the measurement time Tt of the timer has reached the ambient temperature update time Tr, the processing proceeds to step S306. In a case where the control unit 103 determines that the measurement time Tt of the timer has not reached the ambient temperature update time Tr, the processing proceeds to step S308.

In step S306, the control unit 103 obtains the first temperature information Ta, the second temperature information Tb, and the third temperature information Tc from the temperature measuring unit 104.

In step S307, the control unit 103 performs ambient temperature estimation processing. The control unit 103 performs an estimation arithmetic operation for the ambient temperature Te by substituting the first temperature information Ta, the second temperature information Tb, and the third temperature information Tc obtained in step S303 into equation (1). The control unit 103 then notifies the user of the obtained ambient temperature Te by displaying it on the display unit 108 as illustrated in FIGS. 5A and 5B.

In step S308, the control unit 103 determines whether an outer casing temperature T1 of the electronic apparatus 101 has reached an outer casing temperature threshold T1th or determines whether a heat source device temperature T2 of the electronic apparatus 101 has reached a heat source device temperature threshold T2th. The control unit 103 determines whether the first temperature information Ta has reached a first temperature threshold Tath, whether the second temperature information Tb has reached a second temperature threshold Tbth, or whether the third temperature information Tc has reached a third temperature threshold Tcth. In a case where the control unit 103 determines that the first temperature information Ta has reached the first temperature threshold Tath, the second temperature information Tb has reached the second temperature threshold Tbth, or the third temperature information Tc has reached the third temperature threshold Tcth, the processing proceeds to step S309. In a case where the control unit 103 determines that the first temperature information Ta has not reached the first temperature threshold Tath, the second temperature information Tb has not reached the second temperature threshold Tbth, or the third temperature information Tc has not reached the third temperature threshold Tcth, the processing proceeds to step S302.

The second temperature threshold Tbth is the operation restriction temperature of the heat source device 202 and a fixed value regardless of the ambient temperature Te. The first temperature threshold Tath and the third temperature threshold Tcth are temperatures for the restriction of a rise in outer casing temperature and variably set based on the ambient temperature Te.

For example, in a case where the first temperature threshold Tath at an ambient temperature Te0 is Tath0, the first temperature threshold Tath is obtained from the ambient temperature Te estimated in step S307 according to equation (2) below:

$$Tath = Tath 0 + ( Te - Te 0 ) \qquad ( 2 )$$

In step S309, the control unit 103 notifies the user that the operation of the electronic apparatus 101 is stopped to restrict the operation of the electronic apparatus 101 by displaying the corresponding information on the display unit 108. The control unit 103 performs shutdown processing for the electronic apparatus 101. The shutdown processing includes the processing of stopping the supply of power to the heat source device, the processing of shifting the operation mode of the electronic apparatus 101 to the low power state or the sleep state, or the processing of stopping the supply of power to the electronic apparatus 101.

The ambient temperature estimation processing in step S307 can be executed when the first temperature information Ta and the third temperature information Tc used for an estimation arithmetic operation for the ambient temperature Te decrease or when the electronic apparatus 101 operates on low power consumption (power consumption<power threshold) in addition to a case where the ambient temperature update time Tr has elapsed in step S305.

The present embodiment is configured to reduce the possibility that the estimation accuracy of the ambient temperature Te will deteriorate due to the heat dissipation state differing between a portion cooled by the cooling unit 107 in the electronic apparatus 101 and a portion that is not cooled by the cooling unit 107. In the present embodiment, the timing of executing the estimation arithmetic operation for the ambient temperature Te is controlled based on the operation state of the cooling unit 107. More specifically, the ambient temperature update time Tr is changed based on the cooling capacity corresponding to the operation mode of the cooling unit 107. This enables improving the estimation accuracy of the ambient temperature Te by setting the ambient temperature update time Tr based on the operation state of the cooling unit 107.

In the present embodiment, the ambient temperature update time Tr is determined from FIG. 4 illustrating the relationship with the operation mode of the cooling unit 107 at the time point when the operation state of the cooling unit 107 of the cooling unit 107 changes. In a case where the timer measurement time Tt, which is the elapsed time until step S304, is shorter than the ambient temperature update time Tr after the change, the ambient temperature update time Tr can be changed to the remaining time of the timer measurement time Tt, and the timer measurement time Tt can be reset to 0. Setting the time immediately before a change in the operation state to the instant the timer measurement time Tt elapses to the ambient temperature update time Tr can estimate an ambient temperature in a shorter time when the operation state of the cooling unit 107 has changed.

In step S304, the ambient temperature update time Tr after a change in the operation state of the cooling unit 107 can be set to Tr1 and changed according to equation (3) below:

$$Tr = Tr 1 - a \times Tt \qquad ( 3 )$$

In equation (3), “a” is a weight coefficient corresponding to the operation state of the cooling unit 107 and increases with an increase in the cooling capacity of the cooling unit 107.

According to equation (3), time is obtained by subtracting the time obtained by multiplying the predetermined coefficient a by the remaining time Tt until the elapse of the ambient temperature update time Tr1 set before a change in the operation state of the cooling unit 107 from the ambient temperature update time Tr1 corresponding to the operation state of the cooling unit 107.

This enables performing ambient temperature estimation in a shorter time when the operation state of the cooling unit 107 has changed.

When an ambient temperature is displayed on the display unit 108 to notify the user of the ambient temperature in step S307, arithmetic operation results on ambient temperatures can be reflected stepwise as illustrated in FIGS. 5A and 5B. For example, as illustrated in FIGS. 5A and 5B, when the ambient temperature is updated from 20° C. to 30° C., the user can be notified of the ambient temperature without the user experiencing any feeling of discomfort by updating the ambient temperature every 10 sec for each 1° C. instead of displaying at once the update result corresponding to 10° C.

According to the present embodiment, it is possible to improve the estimation accuracy of an ambient temperature when the electronic apparatus 101 is cooled by the cooling unit 107.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-204910, filed Dec. 4, 2023, which is hereby incorporated by reference herein in its entirety.

What is claimed is:

1. An electronic apparatus comprising:
a cooling unit configured to cool an inside of the electronic apparatus;
a temperature measuring unit configured to measure a temperature inside the electronic apparatus; and
a controller that controls an operation of the cooling unit,
wherein the controller performs processing of estimating an ambient temperature in a usage environment of the electronic apparatus based on temperature information obtained by the temperature measuring unit,
controls a timing of performing estimation processing for the ambient temperature based on an operation state of the cooling unit, and controls an operation of the electronic apparatus based on the ambient temperature.

2. The electronic apparatus according to claim 1, wherein the temperature measuring unit includes a plurality of thermometers that measure temperatures of a plurality of portions inside the electronic apparatus, and
wherein the control unit performs an estimation arithmetic operation for the ambient temperature based on temperature information of the plurality of thermometers and a predetermined arithmetic expression.

3. The electronic apparatus according to claim 1, wherein an operation state of the cooling unit includes a cooling capacity of the cooling unit and a portion to be cooled.

4. The electronic apparatus according to claim 1, wherein the timing is a time interval at which the estimation processing is performed.

5. The electronic apparatus according to claim 4, wherein as a cooling capacity of the cooling unit increases, the time interval shortens.

6. The electronic apparatus according to claim 4, wherein the time interval includes a time interval set in advance based on the operation state of the cooling unit, a remaining time until elapse of a time interval set before a change in the operation state of the cooling unit, or a time obtained by subtracting a time obtained by multiplying a predetermined coefficient by a remaining time until elapse of a time interval set before a change in an operation state of the cooling unit from a time interval set in advance based on an operation state of the cooling unit.

7. The electronic apparatus according to claim 4, wherein the controller provides notification of an ambient temperature updated based on the time interval.

8. The electronic apparatus according to claim 1, wherein the operation state of the cooling unit includes a plurality of driven states and a stopped state.

9. The electronic apparatus according to claim 1, wherein the temperature measuring unit includes a thermometer that measures an outer casing temperature of the electronic apparatus, and wherein the controller obtains a threshold for the outer casing temperature of the electronic apparatus based on the ambient temperature and restricts an operation of the electronic apparatus when the outer casing temperature reaches the threshold.

10. The electronic apparatus according to claim 1, wherein the temperature measuring unit includes a thermometer that measures a temperature of a heat source of the electronic apparatus, and wherein the controller restricts an operation of the electronic apparatus when the temperature of the heat source reaches a threshold.

11. A method for controlling an electronic apparatus, the electronic apparatus including a cooling unit that cools an inside of the electronic apparatus and a temperature measuring unit that measures a temperature inside the electronic apparatus, the method comprising:
estimating an ambient temperature in a usage environment of the electronic apparatus based on temperature information obtained by the temperature measuring unit,
controlling a timing at which estimation processing for the ambient temperature is performed based on an operation state of the cooling unit, and
controlling an operation of the electronic apparatus based on the ambient temperature.

12. The method according to claim 11, wherein the temperature measuring unit includes a plurality of thermometers that measure temperatures of a plurality of portions inside the electronic apparatus, and estimating the ambient temperature includes performing an estimation arithmetic operation for the ambient temperature based on temperature information of the plurality of thermometers and a predetermined arithmetic expression.

13. The method according to claim 11, wherein the operation state of the cooling unit includes information concerning a cooling capacity of the cooling unit and a portion to be cooled.

14. The method according to claim 11, wherein the timing is a time interval at which the estimation processing is performed.

15. The method according to claim 14, wherein as a cooling capacity of the cooling unit increases, the time interval shortens.

16. The method according to claim 14, wherein the time interval includes a time interval set in advance based on the operation state of the cooling unit, a remaining time until elapse of a time interval set before a change in the operation state of the cooling unit, or a time obtained by subtracting a time obtained by multiplying a predetermined coefficient by a remaining time until elapse of a time interval set before a change in an operation state of the cooling unit from a time interval set in advance based on an operation state of the cooling unit.

17. The method according to claim 14, the method further comprising providing notification of an ambient temperature updated based on the time interval.

18. The method according to claim 11, wherein the operation state of the cooling unit includes a plurality of driven states and a stopped state.

19. The method according to claim 11, wherein the temperature measuring unit includes a thermometer that measures an outer casing temperature of the electronic apparatus, wherein controlling the operation of the electronic apparatus includes obtaining a threshold for the outer casing temperature of the electronic apparatus based on the ambient temperature and restricting the operation of the electronic apparatus when the outer casing temperature reaches the threshold.

20. The method according to claim 11, wherein the temperature measuring unit includes a thermometer that measures a temperature of a heat source of the electronic apparatus, wherein controlling the operation of the electronic apparatus includes restricting an operation of the electronic apparatus when a temperature of the heat source reaches a threshold.

21. A non-transitory computer-readable storage medium storing a program for causing a computer to execute a method for controlling an electronic apparatus, the electronic apparatus including a cooling unit that cools an inside of the electronic apparatus and a temperature measuring unit that measures a temperature inside the electronic apparatus, the method comprising:
estimating an ambient temperature in a usage environment of the electronic apparatus based on temperature information obtained by the temperature measuring unit,
controlling a timing at which estimation processing for the ambient temperature is performed based on an operation state of the cooling unit, and
controlling an operation of the electronic apparatus based on the ambient temperature.
